(19) United States
(12) Patent Application Publication
(10) Pub. No.: US 2026/0217181 A1
(43) Pub. Date: Jul. 30, 2026

(54) CARGO STRAP SECUREMENT SYSTEM

(71) Applicant: Nite Ize, Inc., Boulder, CO (US)

(72) Inventors: Dale KARACOSTAS, Boulder, CO (US); Bowden ORMSBEE, Longmont, CO (US); Michael C. BOYD, Boulder, CO (US); Steve LINDQUIST, Broomfield, CO (US)

(73) Assignee: Nite Ize, Inc., Boulder, CO (US)

(21) Appl. No.: 19/458,728

(22) Filed: Jan. 24, 2026

Related U.S. Application Data
(60) Provisional application No. 63/750,859, filed on Jan. 29, 2025.

(51) Int. Cl. B60P 7/08; A44B 11/12

(52) U.S. Cl. CPC B60P 7/0823; A44B 11/125

(57) ABSTRACT

An adjustable cargo tie-down includes a cam buckle and a hook that couple together in a retained manner to reduce accidental disengagement. The cam buckle includes a frame that supports a rear pin and a spring-biased locking cam that clamps a webbing strap. The cam buckle also includes a pin for the hook and a retention feature adjacent the engagement bar, such as a wall or rib extending from a floor of the buckle. The hook receives the pin and is rotatable between a retained orientation, in which the retention feature blocks sliding release, and a release orientation that permits separation. In some examples, the hook includes a spring-loaded locking pin that further prevents unintended release.

This application claims the benefit of U.S. Provisional Patent Application Ser. No. 63/750,859, filed Jan. 29, 2025, the entire disclosures of which are incorporated by reference herein.

### FIELD OF THE INVENTION

Embodiments of the present invention generally relate to an adjustable tie-down device designed to provide a convenient and adaptable solution for securing a load or object to another object during storage or transport.

### BACKGROUND OF THE INVENTION

Cargo securement systems, including those that comprise tie-down straps and cam hooks, are widely used for securing various loads. These devices secure items ranging from smaller objects such as backpacks, gear bags, coolers, tool bags, and tents to larger objects like bicycles and motorcycles. Their versatility makes them indispensable across a broad range of applications. Typical cargo securement systems commonly rely on flexible or semi-flexible straps used in combination with a mechanical buckle to restrain loads during transport. A primary function of these systems is to apply and maintain tension in a webbing strap to prevent load movement under dynamic conditions.

Conventional securement systems generally employ either cam buckles or ratcheting buckles. Cam buckles typically include a spring-biased pivoting cam that presses the strap against a fixed bar or frame to operatively secure one end of the strap. An opposite end of the strap is fixedly interconnected or selectively interconnected to the cam buckle (i.e., removable). These devices offer simplicity, low cost, and quick adjustment, making them suitable for light to moderate loads. Ratcheting buckles address higher load requirements by incorporating a lever-driven ratchet mechanism that winds one end of the strap onto a spool. This configuration provides mechanical advantage and enables significantly higher strap tension.

One drawback of cargo securement systems is inadvertent strap release, typically on the side comprising the removable connection. More specifically, many systems employ a hook configured to selectively engage a pin of the buckle. If not properly connected, or if strap tension reduces, hooks can separate from the pin, thereby releasing the hook from the buckle, which could result in load damage or loss.

Despite extensive development in cargo strap technology, there remains a need for improved buckle systems that provide higher effective tension than conventional cam buckles, greater simplicity and compactness than ratcheting buckles, and safer, more controlled engagement and release. There is further a need for buckle designs that accommodate efficient strap routing, secure load retention under dynamic conditions, and ease of use in constrained environments.

The preceding background discussion is not an admission that the matters discussed above are citable as prior art or common general knowledge. Rather, the general background information disclosed herein is directed at describing the problem(s) associated with the current state of the art, and a need for a better solution.

### SUMMARY OF THE INVENTION

It is one aspect of embodiments of the present invention to provide a cargo securement system that is simple in construction, has a reduced number of components, and overcomes the drawbacks of conventional cargo tie down systems and devices. One embodiment of the present invention prevents hook detachment during installation and use, accommodates various load sizes and shapes, and is operable by a single individual, thereby improving both efficiency and safety in securing loads.

One embodiment of the present invention is generally comprised of a cam buckle and hook, each associated with a webbing strap (often referred to herein as a “strap”). In an alternative embodiment, the components are interconnected to each other by a single strap. In one example, the straps on the cam buckle side and the hook side are at least about 5 feet (approximately 1.5 meters) long. The hook can be adjustably interconnected to its strap, thereby allowing the length of the system to be reduced to fit user needs. One of ordinary skill in the art will appreciate the strap associated with the cam buckle is length-adjustable by design. The straps may be about 1 inch (approximately 2.54 cm) wide, but other lengths and widths are contemplated.

In one embodiment, a first strap segment having a looped end formed by stitching is associated with the hook. A second strap, which also has a looped end formed by stitching, is operatively interconnected to the cam buckle. During use, the loops of each strap are engaged to anchor points, the hook engages the cam buckle pin, and the cam buckle is used to maintain tension around a load. One of ordinary skill in the art will appreciate that a ratcheting cam system may be used without departing from the scope of the invention.

The hook and cam buckle are configured for deliberate engagement and deliberate release. In a representative engagement sequence, the hook is oriented to capture a pin or bar of the cam buckle, the hook is then rotated into a retained position in which internal cam buckle structure inhibits unintended disengagement. For example, the cam buckle may include a wall extending from a floor portion of the buckle that limits hook translation in a direction that would otherwise permit hook detachment. Thus, the user can only release the hook from the cam buckle by reversing rotation and removing the hook from the pin. In some embodiments, the hook includes a selectively deflectable, spring-biased locking pin that drastically reduces or prevents pin translation and/or rotation. In this example, the above-described hook removal sequence can only be achieved when the locking pin is actuated.

The system can be implemented using common strap widths, including straps as described above, and can be offered in modular lengths, including a longer cam buckle strap segment and a shorter hook strap segment. By improving the mechanical capture between the hook and the cam buckle without requiring additional loose hardware, the invention can reduce accidental detachment during setup, handling, or vibration, while maintaining ease of use and manufacturability. One of ordinary skill in the art will appreciate that the contemplated system is configured to improve retention at the cam buckle-to-hook interface while preserving simplicity and low cost.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a top perspective view of a cargo securement system of one embodiment of the present invention generally comprised of a cam buckle, a selectively interconnected hook, and associated straps.

FIG. 2 is a bottom a perspective view of the cargo securement system shown in FIG. 1.

FIG. 3 is a side elevation view of the cargo securement system shown in FIG. 1.

FIG. 4 is a cross-sectional view of FIG. 3.

FIG. 5 is a detailed view taken from FIG. 4.

FIG. 6 is a detailed view taken from FIG. 4, wherein the hook of the cargo securement system has been rotated to allow for separation from the cam buckle.

FIG. 7 is a top perspective view of the cargo securement system of another embodiment of the present invention that includes a selectively deflectable locking pin.

FIG. 8 is a cross-sectional view of FIG. 7.

The following component list and associated numbering found in the drawings is provided to assist in the understanding of one embodiment of the present invention:

| # | Component |
|---|---|
| 2 | Cargo securement system |
| 6 | Hook |
| 10 | Cam buckle |
| 14 | First strap |
| 18 | Proximal end of first strap |
| 24 | Second strap |
| 28 | Rear pin |
| 32 | Rear pin teeth |
| 36 | Locking cam teeth |
| 40 | Locking cam |
| 44 | Pivot pin |
| 48 | Spring |
| 52 | Proximal end of second strap |
| 54 | Cam release lever |
| 60 | Wall |
| 64 | Lower surface |
| 68 | Front pin |
| 72 | Hook end |
| 76 | Opening |
| 102 | Cargo securement system |
| 106 | Hook |
| 108 | Locking pin |
| 112 | Locking pin spring |
| 124 | Second strap |
| 160 | Wall |
| 168 | Forward pin |
| 172 | Hook end |
| 174 | Notch |
| 176 | Opening |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

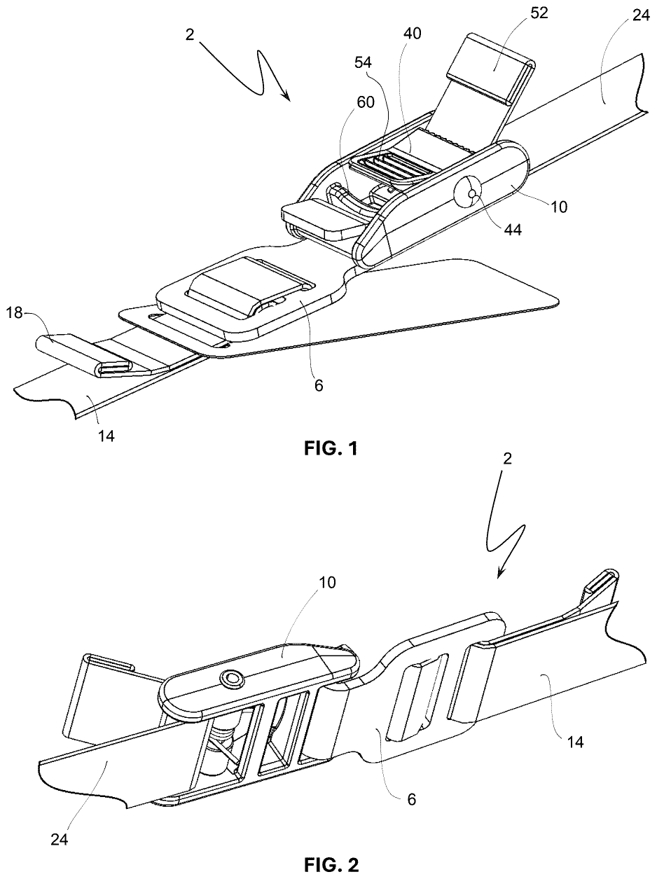

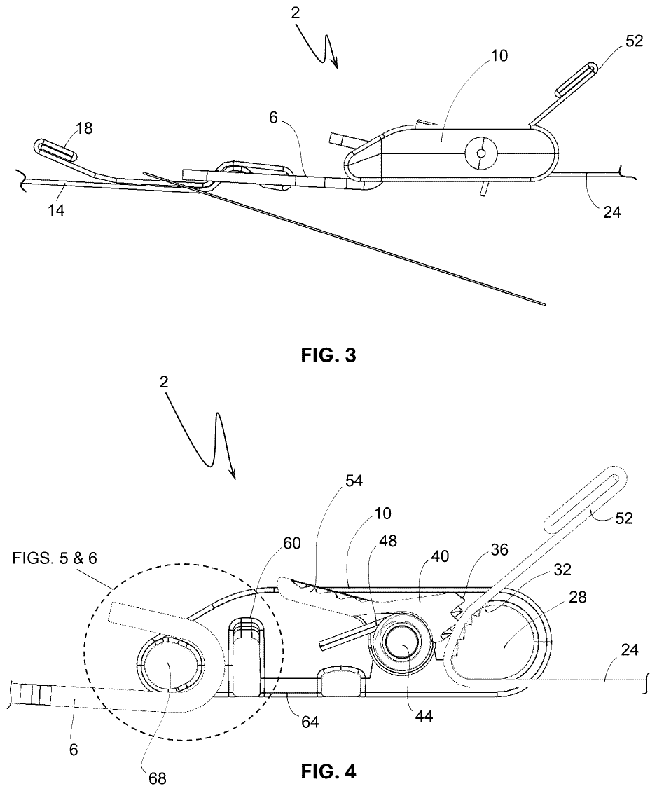

FIGS. 1-6 show a cargo securement system 2 of one embodiment of the present invention generally comprised of a hook 6 configured for selective interconnection to a cam buckle 10. The hook 6 selectively receives and maintains a first strap 14, wherein a proximal end 18 thereof is threaded through portions of the hook 6 in a known fashion to prevent slippage of the first strap 14 from the hook. Likewise, the cam buckle receives and secures a second strap 24 fed around a rear pin 28. As shown in FIG. 4, the rear pin may have a plurality of teeth 32 that cooperate with teeth 36 on a locking cam 40. The locking cam 40 rotates about a pin 44 and is biased by a spring 48 such that teeth 32 and 36 cooperate to grasp a portion of the second strap spaced from its proximal end 52. Depressing a cam release lever 54 rotates the locking cam about the pin 44, thereby separating the locking cam teeth 36 and pin teeth 32 to allow tension of the second strap 24 to be released or adjusted.

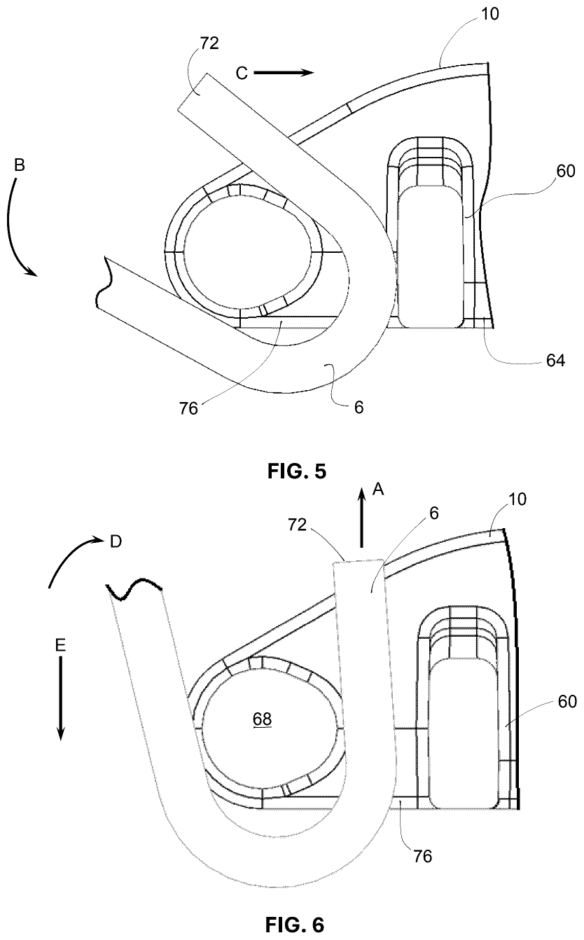

The cam buckle 10 includes a wall 60 extending from a lower surface 64 thereof. The wall 60 is spaced from a front pin 68 adapted to selectively engage the hook. In operation, as shown in FIGS. 5 and 6, securing the hook to the cam buckle is achieved by rotating the hook 6 such that an end 72 thereof is positioned adjacent to an opening 76 in the cam buckle's lower surface 64. Movement of the hook in the direction of Arrow A will eventually cause a portion of the hook to engage the front pin 68, wherein rotation of the hook about Arrow B will direct an end 72 of the hook toward the first strap, securely interconnecting the hook to the cam buckle. The wall 60 prevents substantial translation of the hook in the direction of Arrow C, which helps prevent unintended disconnection. Release of the hook from the buckle is achieved by rotating depressing the cam release lever to release or reduce the tension in the second strap, which allows for the hook 6 to be rotated about the forward pin 68 in the direction of Arrow D, which allows the end 72 to be moved through the opening 76.

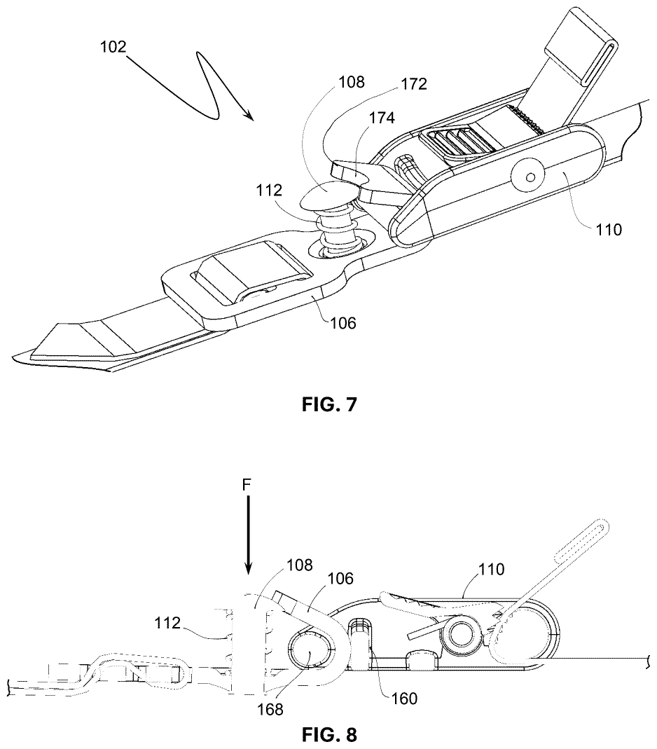

As mentioned above, is one aspect of embodiments of the present invention to prevent unintended this connection of the hook 6 from the cam buckle 10. FIGS. 7 and 8 show the cargo securement system 102 of another embodiment of the present invention, wherein the hook 106 includes a spring biased locking pin 108. Here, a spring 112 engages the surface of the hook and a portion of the locking pin to effectively capture a forward pin 168, wherein no amount of rotation (see FIGS. 5 and 6) will allow an end 172 of the hook to be transitioned through an opening 176 in the cam buckle 110. The hook end 172 may include a notch 174 that allows for the user to push the locking pin in the direction of Arrow F, allowing the hook 106 to move as shown in FIGS. 5 and 6 for engagement and release.

One of ordinary skill in the art will appreciate that the locking pin can take various forms, and the locking mechanism descripted herein does comprise all of the ways hook connection can be maintained. For example, the locking pin can be bolted, riveted, welded, screwed onto, or otherwise fixedly interconnected to the hook, wherein locking of the hook to the cam buckle is permanent or semi-permanent. In alternative embodiments, the locking pin is replaced with a locking member configured to selectively move into place to prevent hook release, such as a locking collar or sleeve, a component configured to slide laterally onto the hook near the forward pin, a magnetically coupled pin, etc., i.e., a separate component.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

It should be noted that all features, elements, components, functions, and steps described with respect to any embodiment provided herein are intended to be freely combinable and substitutable with those from any other embodiment, or with the concepts disclosed in the patents or applications incorporated by reference herein. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that it would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A cargo strap securement system comprising:
a cam buckle having a frame comprised of a floor, side walls, a forward pin supported by the side walls, a rear pin supported by the side walls, a spring-biased locking cam pivotably mounted to the side walls by a pivot pin;
a hook configured to engage the forward pin;
a first strap selectively interconnected to the hook;
a second strap operatively interconnected to the cam buckle; and
wherein, with the hook is received within an opening in the frame and rotated in a first direction to engage the hook onto the forward pin, and wherein rotation of the hook about the forward pin in a second direction, which is generally opposite the first direction, allows the hook to be disengaged from the forward pin and separation of the hook from the cam buckle.

2. The cargo strap securement system of claim 1, wherein the hook comprises a flat hook having a generally planar body.

3. The cargo strap securement system of claim 1, wherein the wall extends upward from the floor along a side of the forward pin.

4. The cargo strap securement system of claim 1, wherein the cam buckle includes a cam release lever coupled to the locking cam.

5. The cargo strap securement system of claim 1, wherein the rear pin comprises a plurality of rear pin teeth and the locking cam comprises a plurality of locking cam teeth that mesh with the rear pin teeth to clamp the second strap.

6. The cargo strap securement system of claim 1, wherein the first strap includes a stitched loop at a distal end, and the second strap includes a stitched loop at a distal end.

7. The cargo strap securement system of claim 1, wherein the hook couples to the first strap by threading a proximal end of the first strap through at least one slot of the hook.

8. The cargo strap securement system of claim 1, wherein the cam buckle comprises a stamped metal body.

9. The cargo strap securement system of claim 1, wherein the wall substantially blocks sliding of the hook relative to the forward pin while the hook remains in a retained position.

10. The cargo strap securement system of claim 1, wherein the hook includes a spring-biased locking pin configured to, in an extended state, movement of the hook out of a retained position.

11. The cargo strap securement system of claim 10, wherein the locking pin moves to a retracted state in response to manual actuation to permit movement of the hook from a retained position to a release position.

12. A cargo securement assembly comprising:
a cam buckle having a body that defines a strap path for a webbing strap, a cam member movable between a clamping position and a release position, and a forward pin configured to receive a hook;
a retention feature on the cam buckle positioned adjacent the forward pin, the retention feature configured to block sliding disengagement of the hook from the forward pin while the hook remains in a retained orientation relative to the cam buckle; and
a hook configured to engage the forward pin and to rotate between the retained orientation, in which the hook cooperates with the retention feature to resist disengagement, and a release orientation that permits the hook to disengage from the forward pin.

13. The cargo securement assembly of claim 12, wherein the retention feature comprises a wall that projects from a floor portion of the cam buckle.

14. The cargo securement assembly of claim 12, wherein the hook comprises a flat hook and includes a spring-loaded locking pin movable between an open position and a closed position that captures the forward pin.

15. The cargo securement assembly of claim 12, wherein the retention feature blocks substantial forward translation of the hook away from the forward pin while the hook remains in the retained orientation.

16. The cargo securement assembly of claim 12, further comprising a first webbing strap coupled to the hook and a second webbing strap coupled to the cam buckle.

17. A cargo securement assembly comprising:
a cam buckle having a forward pin;
a hook configured to receive the forward pin, the hook having selectively deflectable locking member coupled to a hook body and movable relative to the hook body between an open position and a closed position; and
wherein, in the closed position, the locking member blocks removal of the forward pin from the hook.

18. The cargo securement assembly of claim 17, wherein the locking member comprises a spring-loaded pin configured to selectively move through the hook body when depressed.

19. The cargo securement assembly of claim 17, wherein the locking member requires manual action to move from the closed position to the open position.

20. The cargo securement assembly of claim 17, further comprising a webbing strap coupled to the hook body and/or the cam buckle.
